(19) United States
(12) Patent Application Publication
(10) Pub. No.: US 2019/0187782 A1
(43) Pub. Date: Jun. 20, 2019

(54) METHOD OF IMPLEMENTING VIRTUAL REALITY SYSTEM, AND VIRTUAL REALITY DEVICE

(71) Applicant: Huizhou TCL Mobile Communication Co., Ltd, Huizhou (CN)

(72) Inventor: Zhe Liu, Huizhou (CN)

(21) Appl. No.: 16/286,650

(22) Filed: Feb. 27, 2019

Related U.S. Application Data
(63) Continuation of application No. PCT/CN2017/109174, filed on Nov. 2, 2017.

(30) Foreign Application Priority Data
Nov. 2, 2016 (CN) 201610949735.8

(51) Int. Cl. G06F 3/01; G06F 3/16; G06F 9/451

(52) U.S. Cl. CPC G06F 3/011; G06F 3/016; H04M 3/42365; G06F 3/017; G06F 9/453; G06F 3/167

(57) ABSTRACT

The present disclosure provides a method of implementing a virtual reality system. The method may include operations of: generating a stereo interaction scenario, and generating a stereo virtual assistant in the stereo interaction scenario; identifying acquired user input, as computer identifiable data; matching the computer identifiable data, and returning response data which is matched; converting the response data into at least one of a voice signal, a tactile feedback vibration signal, and a visual form signal; and outputting at least one of the voice signal, the tactile feedback vibration signal, and the visual form signal, by an image of the stereo virtual assistant.

### CROSS-REFERENCE TO RELATED APPLICATIONS

The present application is a continuation-application of International (PCT) Patent Application No. PCT/CN2017/109174, filed on Nov. 2, 2017, which claims foreign priority of Chinese Patent Application No. 201610949735.8, filed on Nov. 2, 2016 in the National Intellectual Property Administration of China, the entire contents of which are hereby incorporated by reference.

### FIELD

The described embodiments relate to a virtual reality technology, and more particularly, to a method of implementing virtual reality system, and a virtual reality device.

### BACKGROUND

With the popularity of virtual reality devices, more and more users may spend more and more time in virtual reality (VR) games and applications. However, all currently virtual reality applications do not have an intelligent assistant, to assist users when the users need help.

### SUMMARY

The present disclosure provides a method of implementing virtual reality system, and a virtual reality device, to solve a technical problem that virtual reality applications do not have an intelligent assistant in the related art.

In order to solve the above-mentioned technical problem, a technical solution adopted by the present disclosure is to provide a virtual reality device, including: a processor; a memory coupled to the processor to store instructions, which when executed by the processor, cause the processor to perform operations, the operations including: generating a stereo interaction scenario, and generating a stereo virtual assistant in the stereo interaction scenario; identifying acquired user input, as computer identifiable data; performing an analysis on emotions of the user based on at least one of the input signal and the computer identifiable data; matching the analyzed emotions of the user, and returning response signals; converting the response data into at least one of a voice signal, a tactile feedback vibration signal, and a visual form signal; and outputting at least one of the voice signal, the tactile feedback vibration signal, and the visual form signal, by an image of the stereo virtual assistant.

In order to solve the above-mentioned technical problem, a technical solution adopted by the present disclosure is to provide a virtual reality device, including: a processor; a earpiece coupled to the processor; a camera; a handle with buttons; a loudspeaker; a display; a vibration motor; and a memory; wherein the earpiece is configured to acquire a voice input signal of a user; the camera is configured to acquire a gesture input signal of the user; and the handle with buttons is configured to acquire a button input signal of the user; the loudspeaker is configured to play a voice signal for a stereo virtual assistant; the display is configured to display a visual form signal for the stereo virtual assistant; and the vibration motor is configured to output a tactile feedback vibration signal for the stereo virtual assistant; the memory is configured to store form data of the stereo virtual assistant, and configured to store an input signal and an associated identification signal, an associated matching signal, and an associated conversion signal, acquired by the processor; the processor is configured to acquire the voice input signal, the gesture input signal, and the button input signal of the user for the stereo virtual assistant; the processor is configured to identify the input signal as a processor identifiable signal; the processor is configured to match the processor identifiable signal with the matching signal in the memory; the processor is configured to convert the processor identifiable signal into a user identifiable signal; the processor is configured to output the user identifiable signal by the stereo virtual assistant.

In order to solve the above-mentioned technical problem, a technical solution adopted by the present disclosure is to provide a method of implementing a virtual reality system, wherein the method includes operations of: generating a stereo interaction scenario, and generating a stereo virtual assistant in the stereo interaction scenario; identifying acquired user input, as computer identifiable data; matching the computer identifiable data, and returning response data which is matched; converting the response data into at least one of a voice signal, a tactile feedback vibration signal, and a visual form signal; and outputting at least one of the voice signal, the tactile feedback vibration signal, and the visual form signal, by an image of the stereo virtual assistant.

### BRIEF DESCRIPTION OF THE DRAWINGS

In order to clearly illustrate the technical solutions of the present disclosure, the drawings used in the description of the embodiments will be briefly described. It is understood that the drawings described herein are merely some embodiments of the present disclosure. Those skilled in the art may derive other drawings from these drawings without inventive effort.

FIG. 1 is a flow chart of a method of implementing a virtual reality system in accordance with an embodiment in the present disclosure.

FIG. 2 is a flow chart of a method of implementing a virtual reality system in accordance with another embodiment in the present disclosure.

FIG. 3 is a flow chart of a method of implementing a virtual reality system in accordance with another embodiment in the present disclosure.

FIG. 4 is a flow chart of a method of implementing a virtual reality system in accordance with another embodiment in the present disclosure.

FIG. 5 is a flow chart of a method of implementing a virtual reality system in accordance with another embodiment in the present disclosure.

FIG. 6 is a flow chart of a method of implementing a virtual reality system in accordance with another embodiment in the present disclosure.

FIG. 7 is a structural illustration of a virtual reality device in accordance with an embodiment in the present disclosure.

FIG. 8 is a structural illustration of a virtual reality device in accordance with another embodiment in the present disclosure.

FIG. 9 is a structural illustration of a virtual reality system in accordance with an embodiment in the present disclosure.

### DETAILED DESCRIPTION

The detailed description set forth below is intended as a description of the subject technology with reference to the appended figures and embodiments. It is understood that the embodiments described herein include merely some parts of the embodiments of the present disclosure, but do not include all the embodiments. Based on the embodiments of the present disclosure, all other embodiments that those skilled in the art may derive from these embodiments are within the scope of the present disclosure.

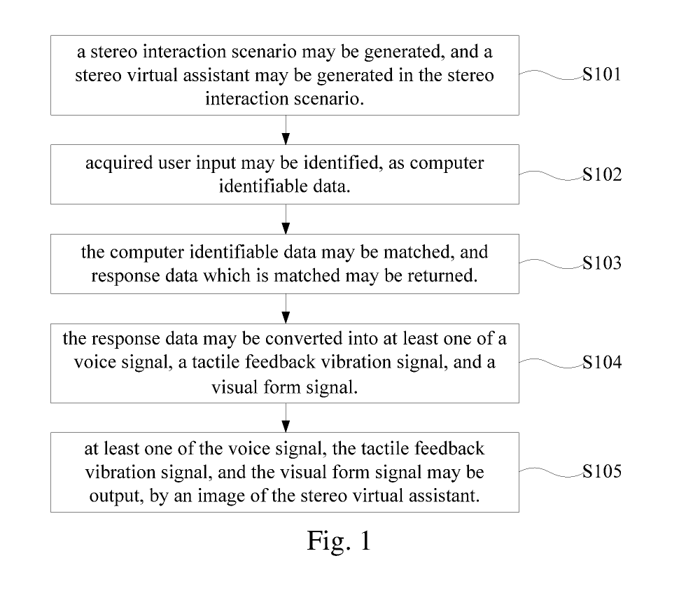

FIG. 1 illustrates that a flow chart of a method of implementing a virtual reality system in accordance with an embodiment in the present disclosure. The method may include operations in following blocks.

Block S101, a stereo interaction scenario may be generated, and a stereo virtual assistant may be generated in the stereo interaction scenario.

When a user experiences a virtual reality device, the user may enter a stereo interaction scenario. In the present disclosure, a stereo virtual assistant may be generated in the stereo interaction scenario. The stereo virtual assistant may be a three-dimensional model in a man type, which may simulate animations with real interactions such as blinking, gazing, nodding, and so on. The stereo virtual assistant may have rich expressions and emotions such as delight, anger, sorrow, and happiness. The stereo virtual assistant may present an expression animation with real emotions such as smile, sadness, anger, and so on, and may provide the user a humanized resonance. The stereo virtual assistant may also be a three-dimensional model in a cartoon type, such as the Garfield, the Pikachu and so on. In other embodiments, the stereo virtual assistant may be customized based on products and applications, so that the stereo virtual assistant may be highly recognizable.

Block S102, acquired user input may be identified, as computer identifiable data.

The stereo virtual assistant may acquire user input in the stereo interaction scenario. The user input may include, but may be not limited to information of the user's voices, button operations, gesture operations, and so on. The stereo virtual assistant may identify the acquired user input as computer identifiable data, i.e., the acquired user input may be performed information conversion.

Block S103, the computer identifiable data may be matched, and response data which is matched may be returned.

The stereo virtual assistant may analyze information of the user input, i.e., the stereo virtual assistant may analyze the computer identifiable data. The information of the user input may be classified, and may be simultaneously processed and responded to basic information, i.e., response data which is matched may be returned.

Block S104, the response data may be converted into at least one of a voice signal, a tactile feedback vibration signal, and a visual form signal.

The response data of the computer identifiable data may be converted into at least one of a voice signal, a tactile feedback vibration signal, and a visual form signal.

Block S105, at least one of the voice signal, the tactile feedback vibration signal, and the visual form signal may be output, by an image of the stereo virtual assistant.

Because the stereo virtual assistant may be a three-dimensional model in a man type or cartoon type, the stereo virtual assistant may have intuitive help and guidance functions. It may reduce communication barriers with users and save costs.

In the present disclosure, a method of implementing a virtual reality system may be provided, to provide a stereo virtual assistant to acquire user input, so as to identify, match, and convert. Thereby, the stereo virtual assistant may output intelligent services that have visual, auditory and tactile functions met user's requirements. A humanized resonance may be provided to the user, and user experience may be enhanced and increased.

In some embodiments, block S103 may specifically be that, the computer identifiable data may be matched with contexts, and response data which is matched may be returned.

In practical applications, the stereo virtual assistant may have an emotional chat function. In the emotional chat function scenario, the stereo virtual assistant may understand contextual meaning of a user's speech, and may perform context analysis on the computer identifiable data. Thereby, response data which is matched may be returned, i.e., contents or answers that the user wants may be returned. In this embodiment, the stereo virtual assistant may have a context-aware function, and may continuously understand contents which continuously interacting with the user. The stereo virtual assistant may be regarded as a smart virtual sprite assistant that may provide the user timely and emotional and companion functions.

In some embodiments, block S103 may further specifically be that, the computer identifiable data may be sent to a remote server, and the computer identifiable data may be matched with web page information or expert system searched by the remote server based on the computer identifiable data, and response data based on search results may be generated and returned.

When information stored in the stereo virtual assistant is not enough to answer questions of a user or meet requirements of the user, the stereo virtual assistant may send the computer identifiable data to a remote server. The remote server may search web page information or expert system based on the computer identifiable data, to match, and response data based on search results may be generated and returned. The stereo virtual assistant may store the response data obtained from the remote server each time, so that when the user or other users asks same questions again, the stereo virtual assistant may provide relevant help and guidance for the user quickly.

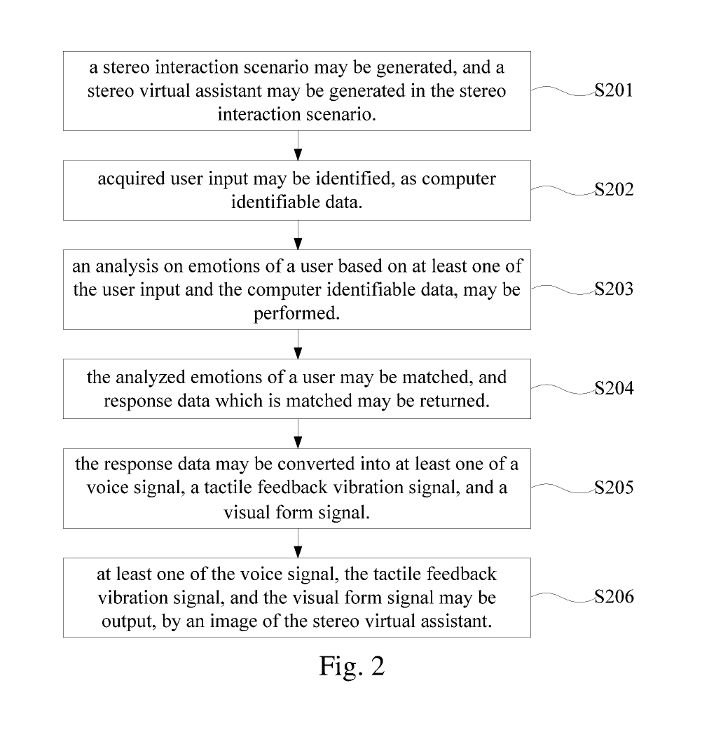

FIG. 2 illustrates that a flow chart of a method of implementing a virtual reality system in accordance with another embodiment in the present disclosure. The method may include operations in following blocks.

Block S201, a stereo interaction scenario may be generated, and a stereo virtual assistant may be generated in the stereo interaction scenario.

Descriptions of block 201 may refer to the above-mentioned descriptions of block 101, therefore no additional description is given herein.

Block S202, acquired user input may be identified, as computer identifiable data.

Descriptions of block 202 may refer to the above-mentioned descriptions of block 102, therefore no additional description is given herein.

Block S203, an analysis on emotions of a user based on at least one of the user input and the computer identifiable data, may be performed.

The stereo virtual assistant may perform an emotional analysis on a user based on at least one of the user input and the computer identifiable data. The emotional analysis may be based on the user's input of tone, speech rate, gestures, textual information of computer identifiable data, and so on, to analyze emotions of the user. The emotions of the user may include happiness, pride, hope, relaxation, anger, anxiety, shame, disappointment, boredom, and so on.

Block S204, the analyzed emotions of a user may be matched, and response data which is matched may be returned.

The stereo virtual assistant may match the analyzed emotions of a user, and may return response data which is matched. The stereo virtual assistant may simulate animations with real interactions such as blinking, gazing, nodding, and so on, and the animations with emotions such as smiles, sadness, and anger, may be presented, thus an emotional resonance may be provided to users. For example, when an emotion of a user is pleasant, a speech signal with fast speech speed, and a smiling expression animation may be fed back; when an emotion of a user is anxious, a speech signal with slow speech speed, and a sad expression animation may be fed back.

Block S205, the response data may be converted into at least one of a voice signal, a tactile feedback vibration signal, and a visual form signal.

Descriptions of block 205 may refer to the above-mentioned descriptions of block 104, therefore no additional description is given herein.

Block S206, at least one of the voice signal, the tactile feedback vibration signal, and the visual form signal may be output, by an image of the stereo virtual assistant.

Descriptions of block 206 may refer to the above-mentioned descriptions of block 105, therefore no additional description is given herein.

In this embodiment, the stereo virtual assistant may analyze emotions of a user and interact with the user. It may provide the user a sense of companionship of friends, to relieve emotional troubles of the user in time. Therefore, willingness of the user's communication, and fun may be enhanced.

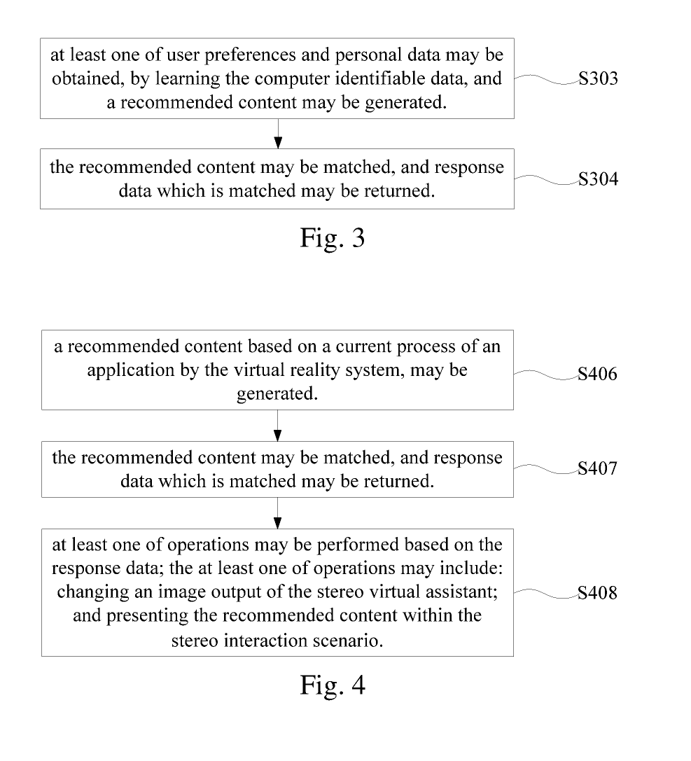

FIG. 3 illustrates that a flow chart of a method of implementing a virtual reality system in accordance with another embodiment in the present disclosure. Operations in this embodiment are the same as the basic procedure flow of the above-mentioned embodiment. The difference is that, an operation in block S303 is replaced with the operation in block S203, and an operation in block S304 is replaced with the operation in block S204.

Block S303, at least one of user preferences and personal data may be obtained, by learning the computer identifiable data, and a recommended content may be generated.

In this embodiment, the stereo virtual assistant may obtain at least one of user preferences and personal data, by learning the computer identifiable data. The personal data may include, but may be not limited to a user's age, gender, height, weight, job, hobbies, beliefs, and so on, to intelligently recommend content with relevant service. The recommended content may also include smart recommendations based on geographic location information. The virtual sprite assistant may provide recommendations and information alerts, such as local traffic conditions, for matched locations, based on the user's country, region, work and living location information.

Block S304, the recommended content may be matched, and response data which is matched may be returned.

The stereo virtual assistant may obtain at least one of user preferences and personal data by learning, to generate a recommended content. The stereo virtual assistant may match the recommended content, and may return response data which is matched

In this embodiment, the stereo virtual assistant may obtain at least one of user preferences and personal data by learning, to more accurately understand and predict requirements of a user, and provide the user with better service. Therefore, it is possible to intelligently recommend an appropriate content to a user, to enrich the user's spare time. The user's after-school knowledge may be expanded, and the user's experience may be enhanced.

FIG. 4 illustrates that a flow chart of a method of implementing a virtual reality system in accordance with another embodiment in the present disclosure. Operations in this embodiment are the same as the basic procedure flow of the above-mentioned embodiment including the operations in block S101 to S105. The difference is that, operations in block S406, block S407, and block S408 are added.

Block S406, a recommended content based on a current process of an application by the virtual reality system, may be generated.

When a user experiences a virtual reality device, the user may also run other applications, such as games, fitness, learning, or entertainment. The stereo virtual assistant may generate a recommended content based on the different applications running by the virtual reality system. The stereo virtual assistant may also generate a real-time recommended content based on a current process of the application running by the virtual reality system. For example, when a user plays a VR game, the stereo virtual assistant may provide help and guidance based on difficulty or the doubt point of the VR game.

Block S407, the recommended content may be matched, and response data which is matched may be returned.

Block S408, at least one of operations may be performed based on the response data; the at least one of operations may include: changing an image output of the stereo virtual assistant; and presenting the recommended content within the stereo interaction scenario.

The recommended content by the stereo virtual assistant may be presented by the stereo virtual assistant, or may be presented directly in the stereo interaction scenario.

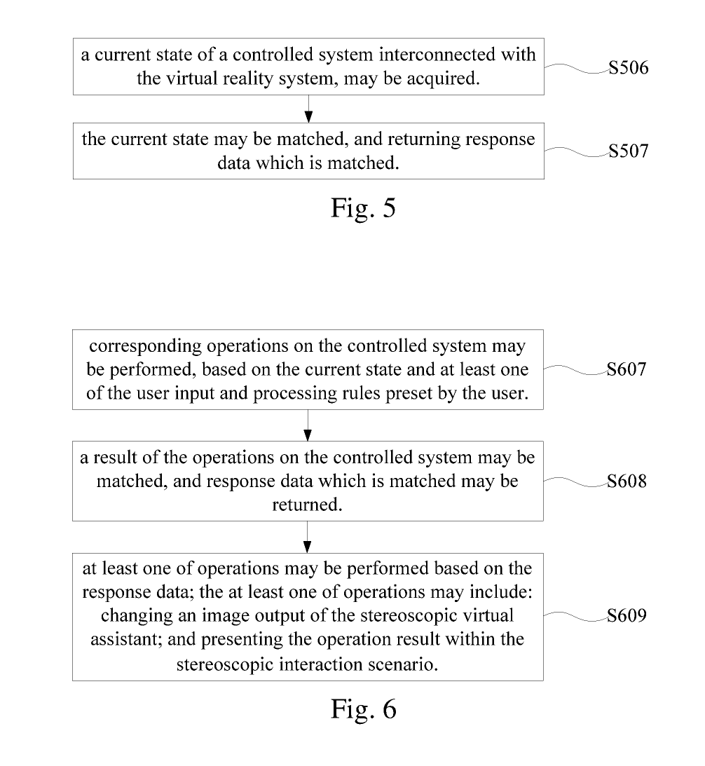

FIG. 5 illustrates that a flow chart of a method of implementing a virtual reality system in accordance with another embodiment in the present disclosure. Operations in this embodiment are the same as the basic procedure flow of the above-mentioned embodiment including the operations in block S101 to S105. The difference is that, operations in block S506 and block S507 are added.

Block S506, a current state of a controlled system interconnected with the virtual reality system, may be acquired.

The virtual reality system may also be associated with other devices outside the system. For example, smart phones, smart cars, smart homes, and so on. Other devices may also be referred to as controlled systems. The stereo virtual assistant may acquire a current state of a controlled system interconnected with the virtual reality system.

Block S507, the current state may be matched, and returning response data which is matched.

The stereo virtual assistant may periodically submit the matched response data of the current state of the controlled system to a user, so that the user may understand the current state of the controlled system.

FIG. 6 illustrates that a flow chart of a method of implementing a virtual reality system in accordance with another embodiment in the present disclosure. Operations in this embodiment are the same as the basic procedure flow of the above-mentioned embodiment including the operations in block S507. The difference is that, the operation in block S507 is replaced with operations in block S608 to block S609.

Block S607, corresponding operations on the controlled system may be performed, based on the current state and at least one of the user input and processing rules preset by the user.

The stereo virtual assistant may be preset processing rules to perform the controlled system. The stereo virtual assistant may perform corresponding operations on the controlled system, based on the current state and at least one of the user input and processing rules preset by the user.

Block S608, a result of the operations on the controlled system may be matched, and response data which is matched may be returned.

Block S609, at least one of operations may be performed based on the response data; the at least one of operations may include: changing an image output of the stereoscopic virtual assistant; and presenting the operation result within the stereoscopic interaction scenario.

In this embodiment, taking the controlled system as a mobile terminal as an application example, it may assume that a current state of the mobile terminal is an incoming call state of the mobile terminal, and preset processing rules may be to hang up or answer the mobile terminal. For example, when a user is playing a VR game, and a mobile terminal has an incoming call or a notification message, the stereo virtual assistant may intelligently recognize importance of the incoming call or the notification message, and may perform a classification processing. When it is a very urgent call, the stereo virtual assistant may notify the user through a floating call notification, or directly answer the call and alert the user by vibration or by pausing the VR game. Otherwise, the stereo virtual assistant may hang up automatically and reply to the call with a text message, such as “I am using a VR device, and I will contact you later.” Corresponding operations of the stereo virtual assistant may include a hanging up operation or an answering operation.

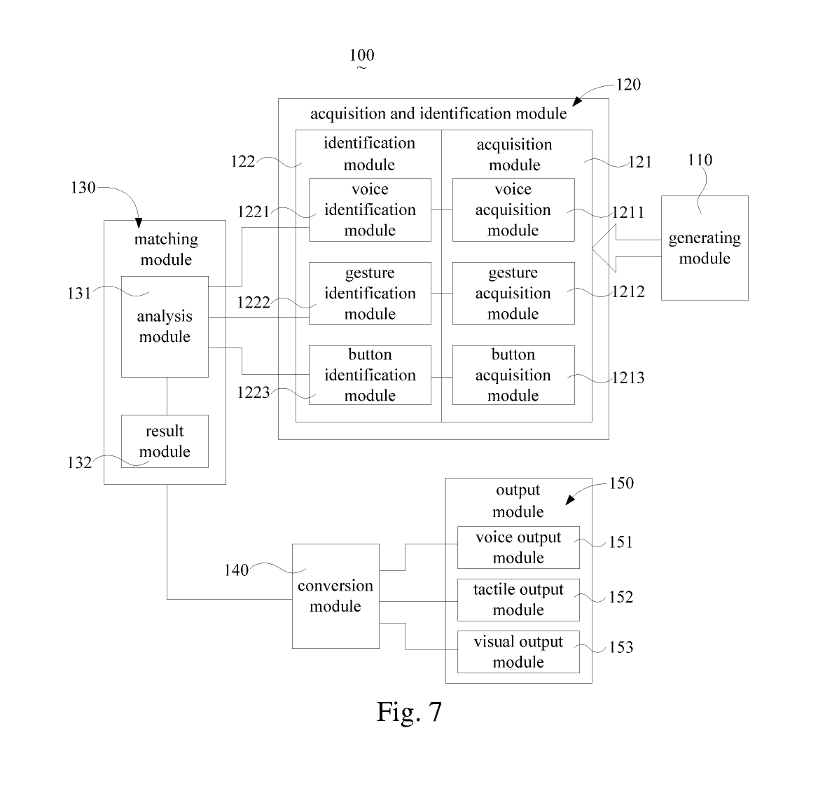

FIG. 7 illustrates a structural illustration of a virtual reality device in accordance with an embodiment in the present disclosure.

The virtual reality device 100 in FIG. 7 may include a generating module 110, an acquisition and identification module 120, a matching module 130, a conversion module 140, and an output module 150.

The generating module 110 may be configured to generate a stereo interaction scenario, and may be configured to generate a stereo virtual assistant in the stereo interaction scenario. The acquisition and identification module 120 may be configured to identify acquired user input, as computer identifiable data. The matching module 130 may be configured to match the computer identifiable data, and may be configured to return response data which is matched. The conversion module 140 may be configured to convert the response data into at least one of a voice signal, a tactile feedback vibration signal, and a visual form signal. The output module 150 may be configured to output at least one of the voice signal, the tactile feedback vibration signal, and the visual form signal, by an image of the stereo virtual assistant.

The generating module 110 may be configured to generate a stereo interaction scenario, and may be configured to generate a stereo virtual assistant in the stereo interaction scenario. In a practical application, the stereo interaction scenario may be a 360-degree panoramic real and three-dimensional interactive environment. The stereo virtual assistant may be designed as a three-dimensional dynamic sprite, a character, or a cartoon character. The stereo virtual assistant may interact with users by various three-dimensional forms and action animation forms in various virtual scenes.

The acquisition and identification module 120 may be configured to acquire user input by the stereo virtual assistant generated by the generating module 110. Information of the user input may include, but may be not limited to a voice of the user, an operation of buttons, and an operation of gestures, and so on. The stereo virtual assistant may also identify the acquired user input, as computer identifiable data.

The acquisition and identification module 120 may include an acquisition module 121 and an identification module 122. The acquisition module 121 may be configured to acquire information input by a user. The identification module 122 may be configured to identify the information acquired by the acquisition module 121, as the computer identifiable data.

The acquisition module 121 may further include a voice acquisition module 1211, a gesture acquisition module 1212, and a button acquisition module 1213. The voice acquisition module 1211 may be acquire a voice input signal of a user. The gesture acquisition module 1212 may be configured to acquire a gesture input signal of a user. The button acquisition module 1213 may be configured to acquire a button input signal of a user. The identification module 122 may also further include a voice identification module 1221, a gesture identification module 1222, and a button identification module 1223, corresponding to the collection module 121. The voice identification module 1221 may be configured identify the voice input signal acquired by the voice acquisition module 1211, as the computer identifiable data. The gesture identification module 1222 may be configured identify the gesture input signal acquired by the gesture acquisition module 1212, as the computer identifiable data. The button identification module 1223 may be configured identify the button input signal acquired by the button acquisition module 1213, as the computer identifiable data.

The matching module 130 may include an analysis module 131, and a result module 132. The analysis module 131 may be configured to analyze and match the computer identifiable data identified by the acquisition and identification module 122. The result module 132 may be configured to feed back results analyzed and matched by the analysis module 131 i.e., to feed back response data which is matched. In other embodiments, the matching module 130 may further include a self-learning module 133. The self-learning module 133 may be configured to learn and memorize a user's usage habits, and may provide targeted reference suggestions when the analysis module 131 performs to analyze and match.

The conversion module 140 may be configured to convert the response data matched by the matching module 130, into at least one of a voice signal, a tactile feedback vibration signal, and a visual form signal.

The output module 150 may be configured to output signals converted the conversion module 140, by an image of the stereo virtual assistant. The output module may include a voice output module 151, a tactile output module 152, and a visual output module 153. The voice output module 151 may be configured to output a signal converted by the conversion module 140, as a voice signal of the stereo virtual assistant, such as a voice broadcast form. The tactile output module 152 may be configured to output a signal converted by the conversion module 140, as a tactile feedback vibration signal of the stereo virtual assistant, such as a vibration form. The visual output module 153 may be configured to output a signal converted by the conversion module 140, as a visual form signal of the stereo virtual assistant, such as forms of animations, expressions, colors, and so on.

The above-mentioned modules of the virtual reality device 100 may perform the corresponding the operations of the method described in the above-mentioned embodiments, therefore no additional description is given herein. Detailed descriptions may refer to the descriptions of the above-mentioned corresponding blocks.

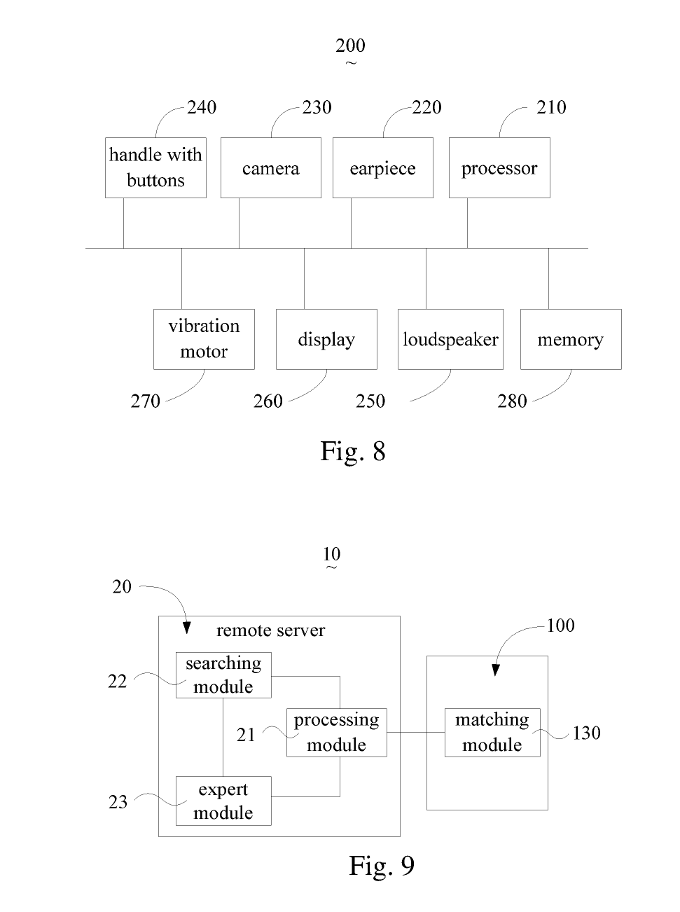

FIG. 8 illustrates a structural illustration of a virtual reality device in accordance with another embodiment in the present disclosure.

The virtual reality device 200 may include a processor 210, a earpiece 220 coupled to the processor 210, a camera 230, a handle 240 with buttons, a loudspeaker 250, a display 260, a vibration motor 270, and a memory 280.

The earpiece 220 may be configured to acquire a voice input signal of a user. The camera 230 may be configured to acquire a gesture input signal of a user. The handle 240 with buttons may be configured to acquire a button input signal of a user.

The loudspeaker 250 may be configured to play a voice signal for a stereo virtual assistant. The display 260 may be configured to display a visual form signal for the stereo virtual assistant. The vibration motor 270 may be configured to output a tactile feedback vibration signal for the stereo virtual assistant.

The memory 280 may be configured to store form data of the stereo virtual assistant, and may be configured to store an input signal and an associated identification signal, an associated matching signal, an associated conversion signal, and so on, acquired by the processor 210.

The processor 210 may be configured to execute operations. The executed operations may be include acquiring the voice input signal, the gesture input signal, and the button input signal of the user for the stereo virtual assistant; identifying the input signal as a processor identifiable signal; matching the processor identifiable signal with the matching signal in the memory 280; converting the processor identifiable signal into a user identifiable signal; and outputting the user identifiable signal by the stereo virtual assistant. The processor 210 may be configured to perform the operations of any one of blocks in the above-mentioned embodiments of the method of implementing virtual reality system shown in FIG. 1 to FIG. 6.

FIG. 9 illustrates a structural illustration of a virtual reality system in accordance with an embodiment in the present disclosure.

The virtual reality system 10 may include a remote server 20 and the virtual reality device 100 described in the above-mentioned descriptions. A structure of the virtual reality device 100 may be described in the above-mentioned descriptions, therefore no additional description is given herein. The remote server 20 may include a processing module 21, a searching module 22, and an expert module 23. The three modules of the processing module 21, the searching module 22, and the expert module 23 may be connected to each other and cooperate with each other.

The processing module 21 may be coupled to the matching module 130 of the virtual reality device 100, and may be configured to process information sent by the matching module 130 and may be configured to feed back processing results. The processing module 21 may send the information to the searching module 22 by a knowledge computing technology, and may perform filtering, recombining, and secondary calculating on knowledge searched by the searching module 22. The information with a high degree of localizations may be more accurately recommended based on information of a user's region and personal preferences, by a questions and answers recommendation technology. The searching module 22 may be configured to search for information provided by the processing module 21 and may be configured to feed back search results. The searching module 22 may use a network search technology and a knowledge search technology to perform a matching search from existing webpage information and information stored by the expert module 23. The expert module 23 may be configured to store structured knowledge. The structured knowledge may include, but may be not limited to expert suggestion data with more human participation factors, for reference by the processing module 21 and the searching module 22. The expert module 23 may also have a predictive function. Some of predictive function may prepare an answer to a question in advance for the user before the user knows that he needs help.

Those skilled in the art may readily understand that, by a virtual reality system, to provide a stereo virtual assistant to acquire user input, so as to identify, match, and convert. Thereby, the stereo virtual assistant may output intelligent services that have visual, auditory and tactile functions met user's requirements. A humanized resonance may be provided to the user, and user experience may be enhanced and increased.

It is understood that the descriptions above are only embodiments of the present disclosure. It is not intended to limit the scope of the present disclosure. Any equivalent transformation in structure and/or in scheme referring to the instruction and the accompanying drawings of the present disclosure, and direct or indirect application in other related technical field, are included within the scope of the present disclosure.

What is claimed is:

1. A virtual reality device, comprising:
a processor;
a memory coupled to the processor to store instructions, which when executed by the processor, cause the processor to perform operations, the operations comprising:
generating a stereo interaction scenario, and generating a stereo virtual assistant in the stereo interaction scenario;
identifying acquired user input, as computer identifiable data;
performing an analysis on emotions of the user based on at least one of the input signal and the computer identifiable data;
matching the analyzed emotions of the user, and returning response signals;
converting the response data into at least one of a voice signal, a tactile feedback vibration signal, and a visual form signal; and
outputting at least one of the voice signal, the tactile feedback vibration signal, and the visual form signal, by an image of the stereo virtual assistant.

2. The virtual reality device according to claim 1, wherein
the user identifiable signal is at least one of a voice signal, a tactile feedback vibration signal, and a visual form signal.

3. The virtual reality device according to claim 1, wherein
the operations further comprise:
matching the processor identifiable data with contexts, and returning response signals.

4. The virtual reality device according to claim 3, wherein
the operations further comprise:
sending the computer identifiable data to a remote server;
wherein
the remote server is configured to search matched web page information or expert system searched by based on the processor identifiable data, and generate and return response data based on search results.

5. The virtual reality device according to claim 1, wherein
the operations further comprise:
obtaining at least one of user preferences and personal data, by learning the processor identifiable data, and generating a recommended content;
matching the recommended content, and returning response signals.

6. A virtual reality device, comprising:
a processor;
an earpiece coupled to the processor;
a camera;
a handle with buttons;
a loudspeaker;
a display;
a vibration motor; and
a memory;
wherein
the earpiece is configured to acquire a voice input signal of a user;
the camera is configured to acquire a gesture input signal of a user; and
the handle with buttons is configured to acquire a button input signal of a user;
the loudspeaker is configured to play a voice signal for a stereo virtual assistant;
the display is configured to display a visual form signal for the stereo virtual assistant; and
the vibration motor is configured to output a tactile feedback vibration signal for the stereo virtual assistant;
the memory is configured to store form data of the stereo virtual assistant, and configured to store an input signal and an associated identification signal, an associated matching signal, and an associated conversion signal, acquired by the processor;
the processor is configured to execute operations comprising:
acquiring the voice input signal, the gesture input signal, and the button input signal of the user for the stereo virtual assistant;
identifying the input signal as a processor identifiable signal;
matching the processor identifiable signal with the matching signal in the memory;
converting the processor identifiable signal into a user identifiable signal;
outputting the user identifiable signal by the stereo virtual assistant.

7. The virtual reality device according to claim 6, wherein
the user identifiable signal is at least one of the voice signal, the tactile feedback vibration signal, and the visual form signal.

8. The virtual reality device according to claim 6, wherein
the processor is further configured to execute operations comprising:
generating a recommended content based on a current process of an application by the virtual reality device;
matching the recommended content, and returning response signals;
performing at least one of operations, based on the response signals, wherein the at least one of operations comprises:
changing at least one of an image output of the stereo virtual assistant; and
presenting the recommended content within the stereo interaction scenario.

9. The virtual reality device according to claim 6, wherein
the processor is further configured to execute operations comprising:
acquiring a current state of a controlled system interconnected with the virtual reality device;
matching the current state, and returning response signals.

10. The virtual reality device according to claim 9, wherein
the acquiring the current state of the controlled system interconnected with the virtual reality device, further comprises:
performing corresponding operations on the controlled system, based on the current state and at least one of the input signal and processing rules preset by the user;
matching a result of the operations on the controlled system, and returning response signals;
performing at least one of operations, based on the response signals, wherein the at least one of operations comprises:
changing an image output of the stereoscopic virtual assistant; and
presenting the operation result within the stereoscopic interaction scenario.

11. The virtual reality device according to claim 10, wherein
the controlled system is a mobile terminal;
the current state is an incoming call state of the mobile terminal; and
the corresponding operation comprises a hanging up operation or an answering operation.

12. A method of implementing a virtual reality system, wherein
the method comprises operations of:
generating a stereo interaction scenario, and generating a stereo virtual assistant in the stereo interaction scenario;
identifying acquired user input, as computer identifiable data;
matching the computer identifiable data, and returning response data which is matched;
converting the response data into at least one of a voice signal, a tactile feedback vibration signal, and a visual form signal; and
outputting at least one of the voice signal, the tactile feedback vibration signal, and the visual form signal, by an image of the stereo virtual assistant.

13. The method according to claim 12, wherein
the matching the computer identifiable data, and returning the response data which is matched, comprises:
matching the computer identifiable data with contexts, and returning response data which is matched.

14. The method according to claim 12, wherein
the matching the computer identifiable data, and returning the response data which is matched, comprises:
performing an analysis on emotions of the user based on at least one of the user input and the computer identifiable data;
matching the analyzed emotions of the user, and returning response data which is matched.

15. The method according to claim 12, wherein
the matching the computer identifiable data, and returning the response data which is matched, comprises:
sending the computer identifiable data to a remote server;
searching matched web page information or expert system searched by the remote server based on the computer identifiable data; and
generating and returning response data based on search results.

16. The method according to claim 12, wherein
the matching the computer identifiable data, and returning the response data which is matched, comprises:
obtaining at least one of user preferences and personal data, by learning the computer identifiable data, and generating a recommended content;
matching the recommended content, and returning response data which is matched.

17. The method according to claim 12, further comprising:
generating a recommended content based on a current process of an application by the virtual reality system;
matching the recommended content, and returning response data which is matched;
performing at least one of operations, based on the response data, wherein the at least one of operations comprises:
changing at least one of an image output of the stereo virtual assistant; and
presenting the recommended content within the stereo interaction scenario.

18. The method according to claim 12, further comprising:
acquiring a current state of a controlled system interconnected with the virtual reality system;
matching the current state, and returning response data which is matched;

19. The method according to claim 18, wherein
the acquiring the current state of the controlled system interconnected with the virtual reality system, further comprises:
performing corresponding operations on the controlled system, based on the current state and at least one of the user input and processing rules preset by the user;
matching a result of the operations on the controlled system, and returning response data which is matched;
performing at least one of operations, based on the response data, wherein the at least one of operations comprises:
changing an image output of the stereoscopic virtual assistant; and
presenting the operation result within the stereoscopic interaction scenario.

20. The method according to claim 19, wherein
the controlled system is a mobile terminal;
the current state is an incoming call state of the mobile terminal; and
the corresponding operation comprises a hanging up operation or an answering operation.
